(19) United States
(12) Patent Application Publication
(10) Pub. No.: US 2024/0200611 A1
(43) Pub. Date: Jun. 20, 2024

(54) Flexible Coupling

(71) Applicants: Michael L. DAVID, The Woodlands, TX (US); REVOLINK, LLC, The Woodlands, TX (US)

(72) Inventor: Michael L. David, The Woodlands, TX (US)

(21) Appl. No.: 18/007,556

(22) PCT Filed: Nov. 5, 2022
(86) PCT No.: PCT/US22/79356

§ 371 Date: Dec. 1, 2022

Related U.S. Application Data
(60) Provisional application No. 63/276,021, filed on Nov. 5, 2021.

(51) Int. Cl. F16D 3/20; E21B 17/05

(52) U.S. Cl. CPC F16D 3/20; E21B 17/05; F16D 2200/0056; F16D 2200/0073; F16D 2500/70408

(57) ABSTRACT

The present invention comprises a flexible coupling device, system and method for transferring high torque loads and complex rotary motion between components or devices. Specifically, high torque loads and complex rotary motions are transmitted from a motor, through and to an input shaft and to an output shaft, by way of a polygonal-shaped, flexible coupling, wherein one component or device may be misaligned with the input shaft. The flexible coupling consists of a reciprocating polygonal ball and socket design exhibiting a spherical, convex cap component made to provide variations and adjustments in alignment though a pivot point where rectangular, flat wear plates are utilized to evenly distribute received weight and elastomeric seals about the neck of the polygonal ball seal functionally sensitive components within a lubricating chamber.

### CROSS-REFERENCE TO RELATED APPLICATIONS

U.S. Provisional Patent Application No. 63/276,021 filed on Nov. 5, 2021

### FEDERALLY SPONSORED RESEARCH OR DEVELOPMENT

Non-Applicable

### RELATED U.S. APPLICATION DATA

This application claims benefit of U.S. Provisional Patent Application No. 63/276,021 filed Nov. 5, 2021.

### FIELD OF THE INVENTION

The present invention relates to a flexible coupling device, system and method of use for transmitting torque and rotary motion between components in a power transmission system, generally. These are particularly well suited for use in downhole drilling motor assemblies to transmit torque and complex rotary motion between a downhole motor power section and a bearing assembly where a plurality of drill pipe sections are utilized. These couplings can also be used to transmit torque and rotary motion in other applications such as vehicles, machinery, and in a varied array of other application where two non-aligned components need to be firmly coupled together to transmit, deliver and even distribute large rotational forces and torque between devices. Flexible couplings are particularly useful in the downhole drilling industry where they are used to connect a plurality of components together in the drilling string.

### BACKGROUND

Torque itself is the amount of force required to rotationally “twist” an object (here a shaft) which is measured in Newton metres (Nm), or pound foot/feet (lb-ft). In the case of downhole drilling, this transmission of rotational power is delivered down a drill string and into a drilling bit. By efficiently equating surface torque with downhole bit rotation and drill pipe behavior, the technology allows drillers to maximize drilling efficiency and improve wellbore quality (due to less trajectory tortuosity) during the sliding part of the drilling process.

Arguably second only to improved drill bit designs and measurement systems, efficiencies in rotary drilling have the greatest potential to provide increasingly better rates of penetration through enhanced capacity for more effectively transmitting high torque from a rotary engine energy source through the drill string and to a bottom hole assembly (BHA).

Flexible couplings are particularly desirable where, as it is in the present case, there is a need to connect a rotary drive source (i.e., motor) to drilling assemblies. This is especially the case where misalignment is inherently problematic, but anticipated, due to the nature of the components and the surrounding environment. Flexible couplings are therefore used in various applications where there is a need to transmit rotary power from the drive source to an auxiliary device which may not have perfect axial alignment between the two devices and where misalignment occurs dynamically and temporally and where misalignment may be incidental or purposeful.

A downhole motor, often referred to as a Moineau motor or progressive cavity pump (PCP) or progressive cavity displacement pump (PCDP) requires a device to convert the complex motion of a motor to simple rotation about a single axis. The Moineau pump has the ability to pump thick, viscous products (i.e., drilling fluid, drilling mud or simply mud), without waste or spoilage, to create eccentric motion. This motion is then transferred to the drill bit as concentric motion, causing or facilitating drill bit actuation. Typically, a PCDP is comprised of two elements: a helical (spiral) rotor, receiving a fluid, and an elastomeric stator, encapsulating the entirety of the rotor and confining each discrete cavity, which itself may be helical in construction. The rotor's two or more cavities appear in series along the length of a rotary shaft and provide a progressive pathway for injected fluid from the point of insertion to the point of egress. As fluid moves within each chamber or cavity, the rotor turns, fluid moves along a dedicated path thereby inducing rotation. Equally, as the rotor turns inside of the stator, cavities move in a spiral-manner from one end of the stator to the other, creating a pumping action. Beginning at suction and continuing along the rotor-stator assembly axially until discharge, wherein the actual flow rate depends on many factors including number of chambers within the rotor, number of “lobes” in the stator, rotor diameter, pump eccentricity and length of stator pitch wherein head rating is related to cavity number. Advantages of the PCP includes increased displacement commensurate with the number of lobes, low rotor imbalance (due to lower value of eccentricity, the ability to increase head rating by increasing the number of lobes, the ability to withstand large flow rates a low rotating speeds, self-priming nature and, potentially most attractive, uniform flow rates without pulsation or sudden jerking movement.

The ‘Flexible Coupling’, also known as simply a coupling, universal joint, or transmission, or the like, is used to connect the downhole motor to the device or apparatus it is driving, typically a load absorbing bearing assembly, and to transmit the torque and rotation from the motor to the bearing assembly and drill bit assembly.

In downhole motors, a transmission is required to transmit the torque created by the motor section to the bearing section and ultimately the drill bit. Due to the nature of the motors, you have a spinning element which rotates but eccentrically (i.e., there is variance and movement from this spinning motor and the center line of the tool string). Depending on motor size, this can move up to 1 inch radially from the center line. The need for a transmission is required to take the eccentrically spinning parts and transfer that torque to a centrically spinning bearing and bit section of the BHA (Bottom Hole Assembly). A Transmission section of a drilling BHA may also contain a bend section, exacerbating this fluctuation. These transmissions are subject to high torque loads and often are the weakest link of downhole BHA components. This limitation means operators are not using the full HHP (Hydraulic Horsepower) drilling capacity of their rigs and mud pumps which transmit the power from surface to the downhole motor and drilling BHA. With a recent downturn in drilling activity, older rigs have been replaced by newer rigs with higher HHP capacity but, as described, limitations are placed on transferring that same horsepower to the BHA. In industry today, the transmission is the weak link in the chain from surface to bit. The downhole components are also exposed to high loads, vibration, abrasive mud invasion and more, shortening the life of the BHA through increased wear and incurring repair and replacement costs. All of these issues negatively affect BHA performance as well as longevity. The present invention (i.e., HEX DRIVE™) addresses each of these challenges and is vastly superior to the prior art in terms of efficiency, effectiveness, and total performance.

Where a coupling must allow for the misalignment of the axis of the motor, coupling, and bearing assembly, this misalignment is typically 3 to 4 degrees but may be more or less as circumstances, environment and use dictate where already harsh environmental conditions may rapidly change negatively effecting functional capacity of couplings. Under normal operating conditions experienced by the drill string, several factors, including flexibility, wear and durability, among others, greatly influence the overall performance of the joint assembly and the rapidity with which inspection, repair and preplacement occur.

Although there exist many different transmission modalities designed to transfer rotational power from a power source, through one to plurality of intermediary assemblies and to terminal tools (e.g., drill bit), each suffers from infirmities the present invention seeks to remediate. In general, there are two types of couplings: a Knuckle Joint (KJ) and a Universal Ball Joint/Drive (UBJ/UBD) with their implementation and utilization comprising each fully ½ of the available couplings in downhole production.

As represented in FIGS. 1-4, each of the prior art couplings, as well as the present invention in FIGS. 4-14, are depicted and comparatively so in FIG. 4. As shown in FIG. 4, the Knuckle Joint (KJ) of FIG. 1 appears to the left, the Universal Ball Joint/Drive (UBJ/UBD) of FIG. 2 is centrally depicted and the present invention (as shown in FIGS. 5-16) is presented right in FIG. 3. These differences are recounts in FIG. 3 and visually represented in FIG. 4.

### Knuckle Joint (KJ)

The Knuckle joint is the oldest and most common type of transmission in the oil and gas industry, used in both surface and downhole applications, that transmits torque between 2 moving elements. Approximately 50% of transmissions in the oil and gas drilling industry utilize the knuckle joint (KJ). Although ubiquitously used in the oil and gas industry as a result of their simplicity, deficiencies in design make the Knuckle Joint assembly particularly inefficient and prone to failure. First, the torque load is applied to the 2 sides of the knuckle, where these 2-point loads limit the amount of torque capable of being applied to the transmission before failure. This transmission type is fairly simple in terms of components but is known for creating high vibrations, and consequently high friction, which fatigues components and leads to high failure rates thus severely limiting the tool life. Pointedly, in a “stick slip” event, one where connecting components suddenly jar or spontaneous shock, common in drilling, these loads can be quite high and instantly change direction of load in such events. Further, the drilling mud is exposed to the transmission components where the abrasive nature of these fluids weaken the part, or connected parts, over time. Although the cost of these transmissions are relatively low, the short life of the components require multiple runs and replacements in a well to complete drilling due to failures.

As detailed in FIG. 1, there are two instances of line contact when the KJ is new and unused. In operation, as the KJ runs, these lines wear and deform, resulting in a very narrow face contact. The gap (slop) allows more impact loading on contact surfaces (i.e., points of contact) especially when a tool is near or into “stick-slip” conditions. Pressure is concentrated at the “ears” of the KJ which causes a “hammer effect” and cracking in the corners of the “ears” and ultimately failure of the tool at its weakest (most vulnerable) parts. Pressure at these vulnerable communications also results in vibration (noise) which only increases with use. This vibration proves especially deleterious to Measurement While Drilling (MWD) data and transmissions. Excessive susceptibility to wear at these few pivotal positions ultimately results in friction-induced wear over a relatively short span of time greatly decreasing the lifespan of the KJ and thus the tool itself.

### Universal Ball Joint (Ball Drive)

To address the challenges seen with traditional knuckle joints, the industry has moved to the Universal Ball drive transmission. Used on the remaining 50% of BHA's in the market, the Ball drive system is able to transmit more torque to the BHA exhibiting fewer failures. Although an option with limitations, operators are forced to accept many of the shortcomings this drive presents and the inherent inadequacies for want of a better solution. Some of the challenges seen with this type of drive are, due to the failures in the BHA, operators are compelled to restrict the amount of torque that can be applied to the BHA. By limiting weight on bit, revolutions per minute (RPM) and rate of penetration (ROP) drillers are able to ensure the integrity of this component but at a cost of innate production losses. Therefore, producers are forced to trade better drilling performance for operational integrity to ensure this part maintains its functional competency. Pushing the Ball Joint Drive beyond its capacity would inevitably cause additional bit run in turn causing even poorer performance.

The Ball Joint Drive itself utilizes 8 balls reciprocal drive slots (i.e., races) transmitting torque to these 8 load points. Fundamental to the design, drilling mud and abrasives invade the tool through a rubber mud boot and abrasives predictably get between the ball and race. If any of the individual balls changes in shape, due to sheer or fracture, deformities result in an uneven distribution of load, which in turn creates vibration of the tool string, leading to a critical and catastrophic failure of the tool. Of note, only 1 ball need fail, of the 8 balls, to fail completely. What is more, it is important to note that the number of operational components in this type of system allows for multiple potential failure points. And, with a failure, the entire tool is destroyed wherein a defective ball will wear into the races and the slop, movement is induced in the component which means that the complete drive must be removed and replaced before being inserted into a new well or BHA.

As shown in FIG. 2, the ball drive C-V joint has actually only two points of contact, the 1 of 8 balls having the largest comparative size to the other 7 balls and that ball directly across from that largest size ball, when new, despite its 8 drive balls. When in operation, the high contact load at those two points quickly wear the contact point in the drive slots within the housing. As more wear occurs more balls begin to share the load whereby load is more evenly distributed between the 8 balls acting as 8 point loads. While this is desired, the total contact area remains relatively small in comparison to the potential points of contact. Since the drive slots are slightly larger than the ball diameter, a shifting of the load point can occur under “stick slip” conditions causing more wear on each side of the slot causing ball breakage. Balls being comparatively harder than the slots, less wear is experienced on the balls than on slots. This tool, as it is used, creates more and more downhole vibration with use, which can have a negative impact on BHA performance. Slots wear, impact load across the balls is increased and, in harsh drilling conditions, ball fracturing can occur across the shear plane and cause a complete failure of the drive.

### Hex Drive System

The Hex drive was developed to address and overcome the challenges with the traditional transmissions (detailed above). Recently tested to take 60,000 ftlbs of torque, inventor exceeded the testing machine and was unable to fail any of the components above 60,000 ftlbs of torque. Inventor was able to achieve these high loads due to the unique design of the present invention (Hex drive) and the addition of load receiving wear plates. Utilizing a male flat or curved-face HEX section, instead of applying a load via 6 points, inventor has added an armored flat wear plate which distributes the load over the cross-sectional area of each wear plate (increasingly as use is continued). Purposely, there exists a line load along the perpendicular face of the hex face, said line load being distributed via wear plates to a greater surface area. This allows more torque through the system and distributes these loads more evenly. Because of the even loading, less vibration is seen than with traditional BHA's which leads to better tool performance for the entire BHA. Another benefit of the present system is the placement and replacement of very few components (e.g., wear plates) and, in the circumstance of wear plate failure, the failure of a single plate would not catastrophically fail the entire tool allowing for continued operations despite breakage or wear. This key advantage allows operators to continue its use without catastrophic failure. Another advantage is repair and replacement where even failure of one component may be remedied through repair or component replacement allowing the tool to be reconditioned, inspected and redressed for future use.

As shown expressly in FIG. 9, when new, the load is shared unevenly across the reciprocating surfaces (i.e., “ashtray”) from an inserted hexagonal (i.e., “mushroom”) as received from motor torque distributed down and through a drill string. This is borne, unevenly, by opposite pairs of wear plates (when wear plates are utilized). This is due primarily to small tolerance gaps between components. In use, the load distribution along the contact lines decreases and is concentrated at the corners of the hexagonal “mushroom”. As the tool runs, though, material near these corners begins to plastically deform resulting in a contact patch on each face of the “hex” (each face ranging from an outwardly, slightly curved surface to a flat facing surface) resulting in an eventual larger facial contact area between the polygonal faces of the “male” hexagon and the reciprocally receiving faces of “female” socket. This allows for the total load to be distributed over a much greater area than the prior art C-V joints wherein greater areas of contact leads to greater distribution of load, higher resistance to impact during slip-stick conditions and thus less susceptibility to jarring breakage and failure. Too, the distribution of load across the face of a wear plate creates a tighter connection between components which results in lessened vibration and decreased noise which may interfere with MWD data logging and data transmission.

In operation, drill string torque comes from the top drive or rotary table turning the entire drill string including the mud motor and drilling rock bit. Mud motors have 3 sections: (1) a power section which contains the rotor and stator, (2) a transmission section—which contains the drive shaft, and (3) a bearing section which contains the mandrel, radial and thrust bearings. Mud motor torque comes from the drilling fluid pumped through the drill string and through the motor power section which is then transmitted to the drive shaft. Then from the drive shaft drilling fluid is pumped to the mandrel, contained in the bearing section, and ultimately to the drilling rock bit. Bend angles on the motor will vary where bend angles are set in the bearing section of the motor housing. Fixed bend motors can go from 0 to 3 degrees in ½ degree increments. There are also motors that have adjustable bends that vary from 0 to 3 degrees where the adjustable bend angle is usually set in the motor shop but can also be set in the field at the drilling rig. The bends angles on the adjustable bend housing can be set in ½ degree increments. Importantly, due to its design, the present invention transmission can flex from zero to up to 6 degrees inside the transmission envelope of the mud motor. Conversely, knuckle joint and ball race (universal ball joints) can flex up to 3 degrees inside their respective transmission envelopes.

In manufacturing, the main body of the drive and the boot sections require the most machining and provide the greatest cost of the tool. From a maintenance perspective, the present invention can be inspected and redressed allowing the consumable wear plate components to be changed after individual failure or periodically as needed where replacement may even be completed preventively. Lastly on the abrasion front, inventor utilizes a unique seal assembly and retainer ring which keeps drilling fluids and solids out of the grease filled coupling area of the transmission in order to decrease mud seepage into the critical components of the device. The retaining ring also acts to hold the ball socket together with the transmission in the unlikely event of a break occurring at the neck area. This enables operators to retrieve all components from the Well and avoid potential fishing interventions. These components are superior to the rubber boots that are utilized in the ball drive transmission systems and provide a seal against seepage of debris ladened mud into the functional components of the device.

It is the goal of inventor to implement the new and novel features of the present invention to address the unaddressed and long-felt need in the art to more effectively transfer torque and complex rotary motion from one shaft to an output shaft that may be misaligned with the input shaft and to operate a flexible coupling as to remediate the deficiencies defined herein.

### BRIEF SUMMARY OF THE INVENTION

Typically, the coupling that is the present invention may consist of one or two joint assemblies connected to one or both ends of an intermediate shaft. The joint assembly consists of a multi-sided or polygonal (e.g., hexagonal or octagonal) ball which is integral to the intermediate shaft's exceptional function whereby the hexagonal head is inserted into a reciprocally mating socket. A series of wear plates may be used to isolate the hexagonal ball from the socket and distribute the force created and applied to an originating, intermediate or terminal shaft or to the drill bit itself. The exposed end (i.e., cap) of the hexagonal ball is generally “spherically” shaped with a radius equal to the hexagonal ball. Both the hexagonal ball and the spherical or orbicular surface cap have a common center point. This spherical surface is the pivot point of the hexagonal joint allowing for transitory changes in trajectory and angle. The spherical surface may be integral to the hexagonal ball or may be a separate entity. The spherical surface sits in a similarly radiused bowl or depression in the bottom of the hexagonal socket. This bowl can be either integral with the socket or it can be a separate placeable and replaceable entity.

The bowl and spherical surface are load bearing surfaces that provide a pivot point for each joint as well as absorbs any downthrust produced by the downhole motor or intermediary shafts. The joint assembly is packed or filled with a lubricant such as oil or grease where an elastomer plug or seal is used to seal the lubrication cavity and isolate, seal and protect (from leakage and damage) the cavity from outside contaminants inherent in the drilling mud. A retaining ring is used to lock the elastomer plug in place and slightly compress the retaining ring as to create a tighter seal to better isolate the lubrication cavity from unwanted debris wherein said debris enhances wear and hastens time to replacement and repair.

An additional load ring may be further attached to the intermediate shaft to prevent the joint assemblies from being dislodged. The load rings and the retaining rings are dimensioned so that one end of the retaining ring is larger than the load ring enabling the retaining ring to fit over the load ring. The opposite end of the retaining ring is smaller than the load ring, preventing it from passing through. Sufficient clearance is provided between the parts to allow for the articulation of the intermediate shaft.

The present invention comprises a shaft and one to two end couplings. The end couplings have the ability to pivot in a limited spherical arc about a fixed pivot point at each end of the shaft. The shaft and the end couplings are keyed together in such a fashion to allow rotational translation and torque to be transferred from one coupling to the other coupling. Provisions are included to allow for axial loads to be absorbed or compensated for. The intention of this invention is to provide a higher torque capable alternative to current or conventional KJ and/or universal joint assemblies or couplings.

Operationally, the present invention relates to 6½″/6¾″ OD Motor Assemblies but may be modified to accommodate motor assemblies of various sizes (ex., 1″ to 24″ motor assemblies) and capacities both within and outside of the drilling industry. The 6½″/6¾″ OD Motor Assemblies are used herein in a representative capacity where the 6½″/6¾″ OD Motor Assemblies are historically the most difficult size motor to engineer for strength and robustness due to the geometrical constraints as compared to the mechanical properties of the materials where it is that larger motors allow for more robust geometrical design capabilities and smaller motors cannot generate the power ratios common to the 6-12″/6¾″ OD Motor Assemblies.

In terms of Torque Capacity, while the present invention is rated for zero to 50,000 ft-lbs. of torque, inventor has tested the present invention (Hex Drive assembly) at 60,000 ft-lbs before reaching the limits of testing machinery. The upper limit therefore may go well beyond this 60,000 ft-lbs. as testing capacity increases but, even at the capacity, this upper limit is more than double current capacities (defined below).

Current power sections exhibit power sections at an upper limit of approximately 23,000 ft-lbs., where prior art, as well as most other current transmissions, have upper limit ranges of 16,000 to 18,000 ft-lbs. Alternatively, titanium flex shafts have a heightened upper limit (i.e., 20,000 to 22,000 ft-lb), but titanium flex shafts are cost prohibitive and very sensitive to damage like wrench or clamp marks.

In terms of cost, the present invention is comparable to a Universal Ball Drive/Joint (UBD/UBJ), but, as is provided, is superior in terms of functionality where the present invention is capable of considerably higher torque loads (60,000 ft-lbs. as compared to 16,000 to 18,000 ft-lbs.) and has fewer critical components (27 in the present invention and 35 in a UBD). Further, the present invention is currently more expensive to manufacture than a Knuckle Joint (KJ), creating slightly higher cost initially, but this cost is recouped and minimized where wear in the KJ incurs substantial costs in repair and replacement.

When compared to flex shafts, the largest advantage to the present invention, next to advantages in cost, are the ability to achieve bend angles in the short bit-to-bend lengths. Flex shafts have to, by nature of their construction, be much longer than conventional transmissions. This makes short bit-to-bend lengths impossible with flex shafts, which, in turn, severely limits build rates of the bottom hole assembly (BHA). This requires the Well Planner to compromise and choose between build rates or drilling torque both of which are remedied in the present device and method of use.

Additionally, the present invention that is the HexDrive™, while having more critical components then the simpler KJ, has advantages not exhibited by the KJ in terms of torque capacity and extended lifespan and, having fewer parts than the UBD, exhibits ease of assembly and disassembly, in addition to greater torque capacity and useful lifespan where wear surfaces are removable for direct visible and easily measurable inspection all but impossible in the UBD. Specific to KJs, while simple in terms of design and assembly, set screws can become difficult to remove during disassembly and ears need to be inspected for cracking require mag particle inspected between runs which is often forgone in light of a relatively short lifespan and untenable cost. UBDs (Vector types) are even more difficult to assemble, due to greater complexity, and disassembly can be even more difficult causing obstacles to efficient inspection where inspection is generally more subjective (measurable) than objective (e.g., physical and visual inspection).

As alluded to supra, Knuckle joint (KJ) transmissions are typically good for one or three runs or around 100 to 150 hours of drilling time before they are retired. KJs may, and often do, require refacing (welded, hard metal overlay) of the contact surfaces between runs. UBDs (Vector types) are typically good for four or five runs or 200 to 250 hours. They require both balls and the rubber seal boots to be replaced between runs. In another example, Brandell's spline drive (U.S. Pat. No. 4,484,633) rarely gets more than two runs or 125 to 150 hours and requires extensive maintenance and inspection between runs. Re-run cost in the above examples can be high. The present invention that is the Hex Drive, in opposite, is estimated to have a lifespan of 300 or more hours or 6+ runs where re-run cost is expected to be low with the possibility that the wear plates will last at least three runs before requiring inspection or replacement, failure of a single wear plate, in most examples does not constitute a critical failure, and only shaft seals need be replaced between runs.

Comparing the present invention with UBDs vibration, vibration and thus noise is comparable to that of the UBD but is greatly decreased when evaluated with KJs. This is important where looseness of the KJ drive not only causes increases in frictional wear, having a detrimental effect on overall hours of operability, but also in terms of interference with MWD data transmission. Yet, it is also important to note that with use, and wear, the KJ drive continues to illicit vibration at an ever-increasing rate, the UBD begins to become more noisy over time and the present invention, as the polygonal ball and the socket “settle in” and distribute weight more evenly across the reciprocal faces, or wear plates when installed, noise actually decreases over time and with continued use.

Inventor sets forth, in this application, a new novel device, system and method of use to overcome the presented shortfalls in torque transfer and transmittance of rotary power and to provide an novel and innovative means of effectuating these improvements as described herein.

### BRIEF DESCRIPTION OF THE DRAWINGS

Some embodiments of the present invention are illustrated as an example and are not limited by the figures of the accompanying drawings, in which like references may indicate similar elements and in which objects, features and improvements are hereafter set forth and described:

FIG. 1 illustrates prior art that is a Knuckle Joint (KJ);

FIG. 2 illustrates prior art that is a Universal Ball Joint;

FIG. 3 is a comparative analysis of differences between the prior art and the present invention;

FIG. 4 is a visual comparison of the prior art and the present invention;

FIG. 5 depicts a side, sectional view of one example of a downhole drilling apparatus of the present invention;

FIG. 6 is a sectional, schematic view of a flexible coupling taken through the longitudinal axis;

FIG. 7 shows an enlarged section of the upper end coupling showing a male threaded connection, inferiorly represented, together with a bowl-shaped receiving component and spherical entity, superiorly positioned;

FIG. 8 illustrates an encased unit, a cut-away unit with inventive features at either end;

FIG. 9a is a hexagonal functional component of the present invention;

FIG. 9b is an alternative octagonal functional component of the present invention;

FIG. 10 shows an axonometric view of the socket with optional square or rectangularized wear plates;

FIG. 11 is an axonometric view of a socket without said wear plates;

FIG. 12 depicts an isometric view of the connecting shaft with a hexagonal ball at each end;

FIG. 13 is a cross-section of the polygonal ball of FIG. 12, perpendicular to the axis of the coupling, with optional rectangular wear plates (left) and without the optional wear plates (right).

FIG. 14 illustrates a expandable circular spring device;

FIG. 15 is a toroidally shaped seal;

FIG. 16 is an enlarged cross section of coupling showing the elastomeric seal, used to retain lubricating fluids, the split ring, the split ring retainer, and the seal retainer/split ring catch ring.

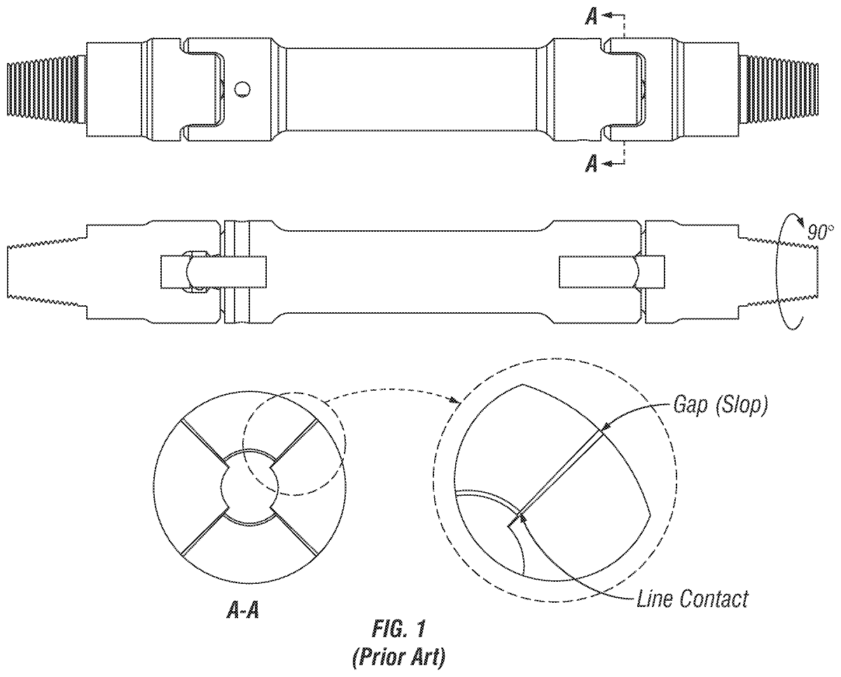

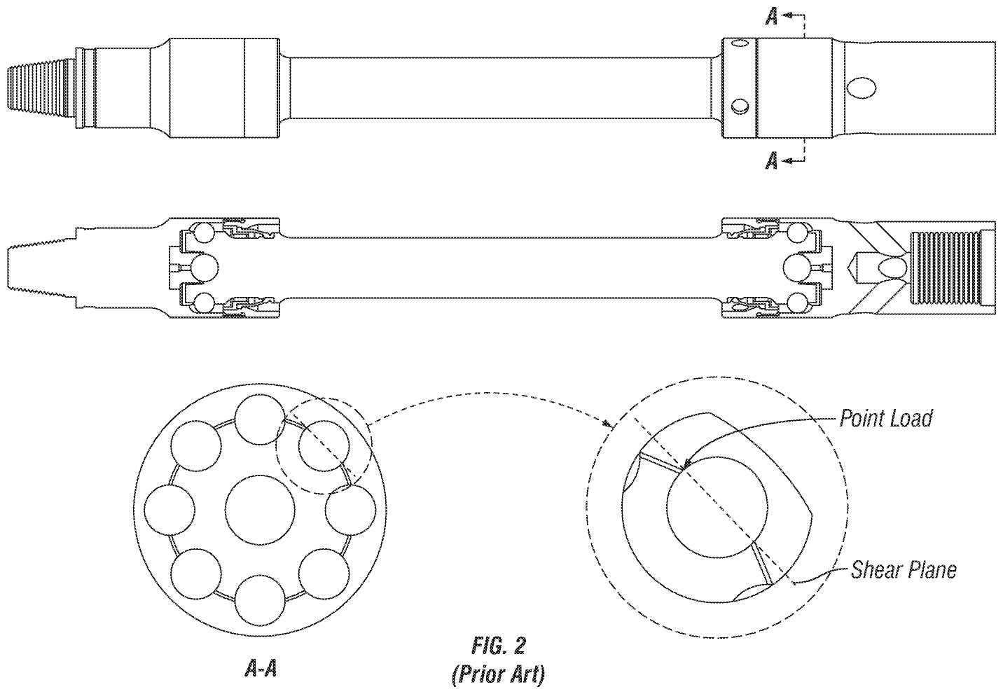

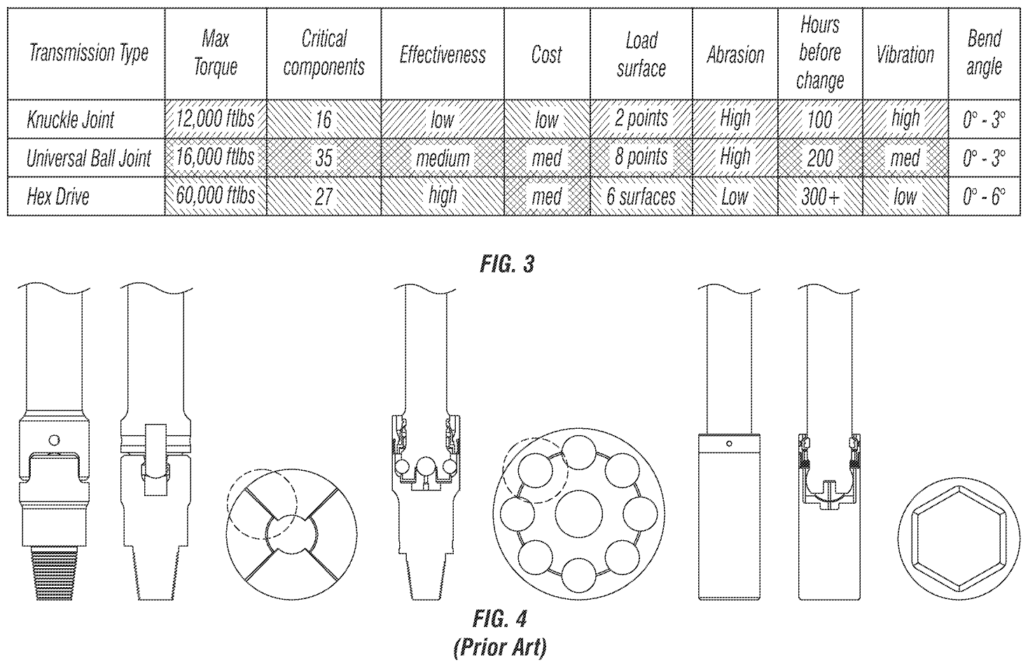

And while the invention itself and method of use are amendable to various modifications and alternative configurations, specific embodiments have been shown herein by way of example in the drawings and are described in adequate detail to teach those having skill in the art how to make and practice the same. It should, however, be understood that the provided description and preferred embodiments disclosed are not intended to limit the invention to the particular embodiment disclosed, but on the contrary, the invention disclosure is intended to cover all modifications, alternatives and equivalents falling within the spirit and scope of the invention as defined within the claim's broadest reasonable interpretation consistent with the specification.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Flexible couplings as described in the present embodiments are desirable for use in joint assemblies as well as other applications wherein large amounts of rotary force must be transmitted to peripherally existing terminal devices as may be seen in areas ranging from downhole drilling to mechanized vehicles and energy generating turbines capable of enduring extremely high loads.

A new coupling device is discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

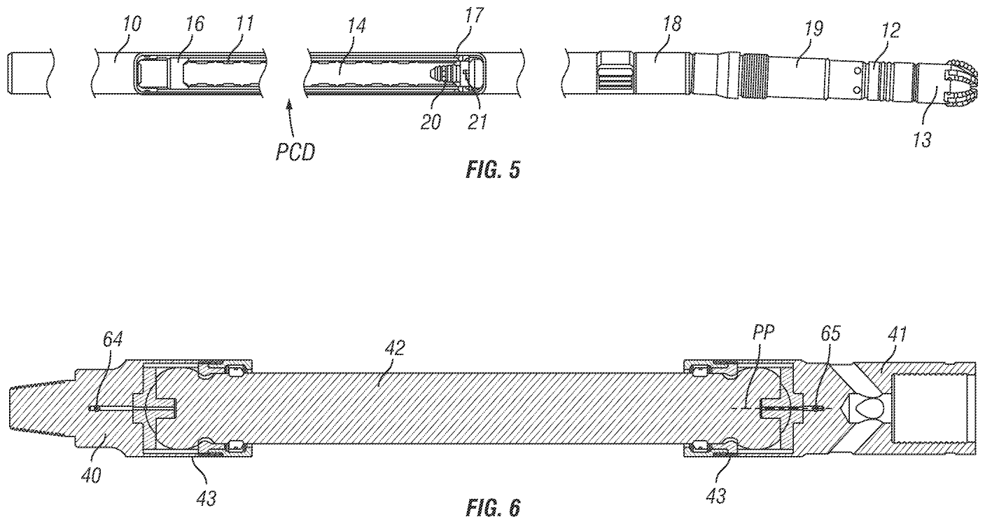

The present invention will now be described by referencing the appended figures representing preferred embodiments. FIG. 5 is a representation of the typical components of a downhole drilling apparatus of the type in which this invention and its various embodiments may be used.

Flexible couplings of the current embodiments are useful when rotating shafts, that are not necessarily aligned, or are intentionally misaligned, and need to be coupled together in order to transfer rotation and torsion between two devices. The invention disclosed here is generally applicable to applications where only limited flexibility is required but superior performance (e.g., high torque capacity) and the ability to operate in harsh and demanding conditions is required. The most obvious example of these conditions is the downhole drilling and pumping environment. The present embodiments are particularly well suited for use in the downhole drilling and pumping environments. Those skilled in the art will recognize that the coupling described herein is useful in other applications where limited flexibility is sufficient but superior performance is required and the operating conditions are extremely demanding. Yet, inventor contemplates other uses wherein the transfer of mechanical rotation is sought and direct alignment is either impossible, impractical or changes due to various factors including offsets, transitions, operational environments or imperfect circumstances.

FIG. 5 shows the common components of a directional drilling tool assembly. The apparatus may include a drill string 10, a progressive cavity power section (motor) PCD, a bearing assembly 18, a drill bit drive shaft 12, and a drill bit 13. The drive train (motor) of the present embodiments may comprise a progressive cavity device and a coupling for converting the complex rotary motion of the rotor 14 into simple rotary motion about a single axis.

Also shown in FIG. 5, the progressive cavity device PCD may have a stator, and an outlet passage 17, for the fluid to exit therefrom. The stator housing and its flexible lining 11, are bonded together so that they function as the stator in device PCD with the rotor 14.

The lower end of the rotor 14 may include a rotor connection 20, The rotor connection 20 allows for the connection of the rotor 14 to the upper flexible coupling connection 21 at the upper end of the flexible coupling (described below).

FIG. 6 is a cross-sectional view of the flexible coupling assembly viewed along the long axis of the assembly. The present embodiment of the invention is comprised of an upper end coupling 40, and a lower end coupling 41, a connecting shaft 42, and a polygonal ball assembly 43.

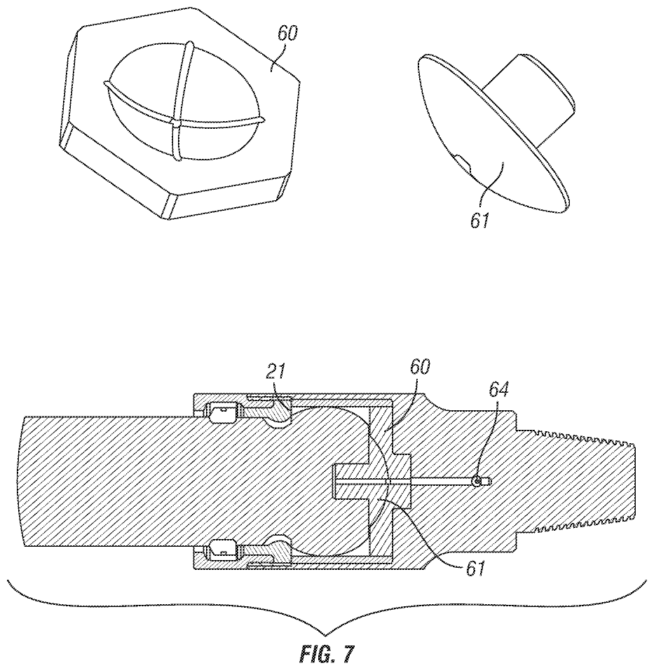

A lubrication port 64, 65 shown in FIG. 7 may be provided in each end coupling to allow lubricating grease or oil to be pumped into the coupling to lubricate the components and fill any air voids. A pipe plug (not shown) or other plug is used to seal the lubrication port.

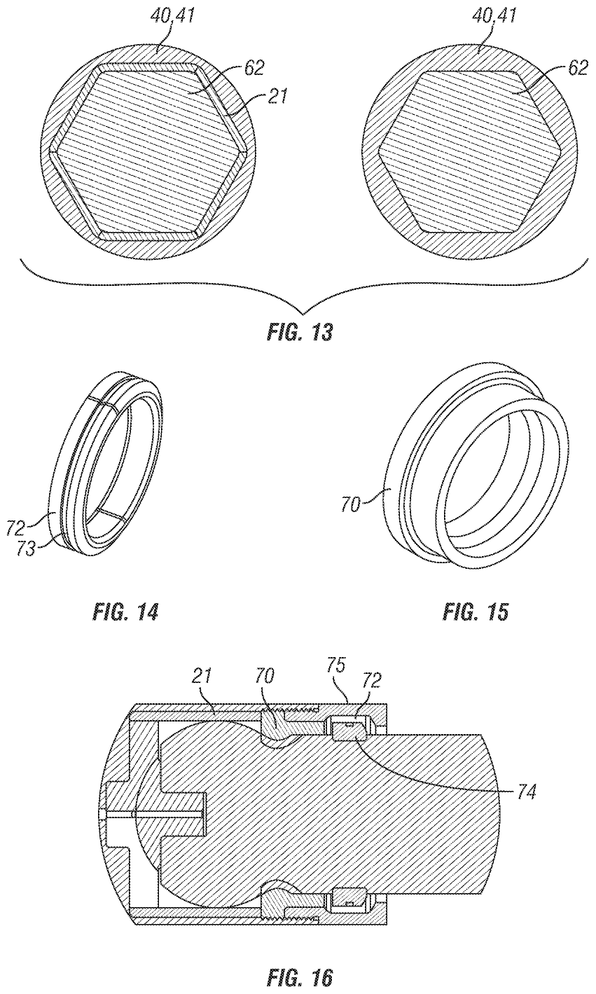

FIG. 8 shows both the encased unit (above) and the pictorial diagram featuring a schematic representation and the functional components of the present device further represented in FIGS. 6, 7, and 10-16.

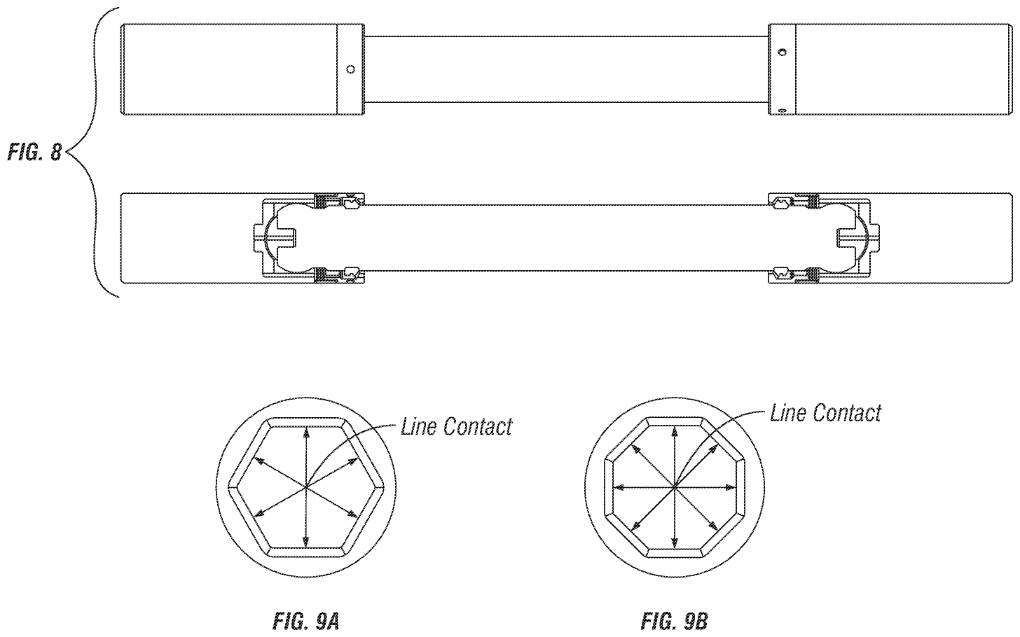

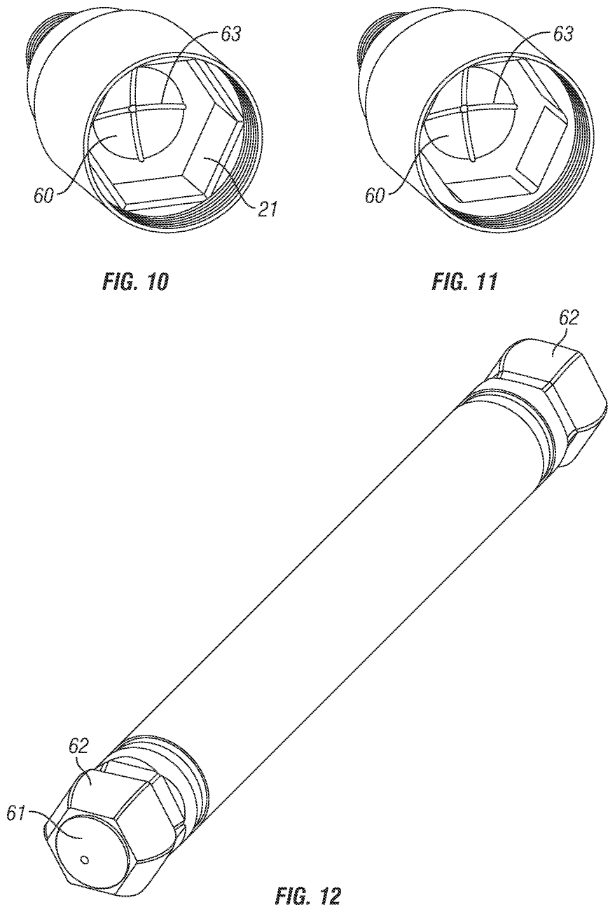

FIG. 9a depicts the distributed weight and Line Contacts experienced when FIG. 12, connecting shaft with a hexagonal ball at either terminal end, is inserted into FIG. 10 and/or FIG. 11, sockets with or without wear plates, respectively.

FIG. 9b is an alternative preferred embodiment wherein an optionally a polygonal ball in the shape of an octagonal ball, one having 8 sides, is illustrated wherein load is distributed across 8 surfaces as opposed to the six sides of FIG. 9a.

Each coupling is configured to have a compatible mating geometry (e.g., similar connections) to the component to which it attaches. Each coupling contains a multi-sided pocket, as shown in FIG. 10 and FIG. 11, often referred to as a socket. Typically, this socket is six-sided, or hexagonal, but any number of sides is allowable. FIG. 10 illustrates a socket with rectangular wear plates 21 (described below) and FIG. 11 shows a socket without rectangular wear plates.

FIG. 12 shows the connecting shaft that connects the upper socket to the lower socket. On each end of the shaft are similarly sized and shaped polygonal (hexagonal) balls 62 designed to fit snugly and smoothly into the sockets shown in FIGS. 10 and 11. In this example, a six sided, or hexagonal balls and sockets are used. The polygonal shaped ball and socket is used to transmit torque and rotary motion from the upper end coupling 40, through the connecting shaft 42, to the lower end coupling 41. The process may be viewed, in principle, as an Allen wrench or ball hex wrench but, where it is the case that an Allen wrench and ball hex wrench utilize motive force through contacts with a socket sides and misalignment is generally untoward, the present invention further leverages pivot points and invites directed load distribution, with or without wear plates, and anticipates misalignment for distribution of torque.

As is explained above, the driven (upper) side of the coupling exerts a significant downward load from the progressive cavity device on the coupling. The coupling must be equipped with a device to distribute that load to prevent excessive wear to the components and to allow for the shaft 42 to pivot with respect to the two end couplings. This device consists of a spherical component 61 forming a head or cap specifically designed to allow for variations in angle and misalignment that can be separate from or integral to the end of the connecting shaft 42. This spherical component must have the same geometrical center as the polygonal ball 62 on the shaft 42 to be functionally operational. This point is defined as the pivot point PP of the coupling.

In the body of each coupling is a bowl-shaped component 60 which can be integral to or separate from the coupling. The diameter of this bowl is, ideally, as large as practical to distribute the download over an area as large as possible. The radius of the bowl must precisely match the diameter of the spherical component 62 on the end of the shaft and must share the same geometrical center point PP. When these two devices are separate entities, the spherical entity 61 is often referred to as a “mushroom” and the bowl-shaped entity 60 is often referred to as an “ashtray”. In all cases these two components are typically manufactured from hard, abrasion resistant materials and have very smooth contact surfaces. Lubrication grooves 63 are often cut into the “mushroom’ to enhance lubrication as to ease frictional wear.

Wear Plates 21, as shown in FIGS. 7, 10, 13 (left), and 16, may be used to limit abrasion between the polygonal ball and the socket. As shown, these largely square, flat wear plates 21 are typically manufactured from hard and abrasion resistant materials. Wear plates themselves having two faces, four sides and four edges wherein each wear plate is flat on each face, and may be of equal or unequal square or rectangular dimensions. Particularly, wear plates are flat on each face and not fitted to match the curvature of the polygonal ball as this will prevent said ball from pivoting properly.

FIG. 15 is a cross section showing the toroidal shaped elastomeric seal 70 used to seal the gap between the connecting shaft 42 and the socket of the end couplings 40, 41. This seal is used to retain lubricating oil or grease encasing the polygonal shaped ball, the socket, and the two, load distribution/pivot point components (“ashtray” and “mushroom”).

As further shown in FIG. 16, a groove 72 is cut into the shaft and a split ring 74, which has been cut apart along a diametrical direction, is placed in said groove. The split ring 74 is retained with an expandable circular spring device 72 such as an O-ring, spring clip, garter spring, or other similar device fitted into a properly sized groove manufactured into the split ring 74.

A retaining ring 75, designed so one end passes over the split ring 74 and the other end does not, is screwed into the end coupling 40 or 41, trapping and compressing the toroidally shaped seal 70 and trapping the split ring 74, thus preventing the end couplings from being detached from the connecting shaft 42.

In one embodiment a flexible coupling device, system and method is used for transferring high torque loads and complex rotary motion between components or devices. Specifically, high torque loads and complex rotary motions are transmitted from a motor, through and to an input shaft and to an output shaft, by way of a polygonal-shaped, flexible coupling. The flexible coupling is made to operate wherein one component or device (e.g., shaft) may be misaligned with the input shaft, temporarily and transitorily. The flexible coupling itself consists of a reciprocating polygonal ball and socket design exhibiting a spherical, convex cap component made to provide variations and adjustments in alignment though a pivot point where flat wear plates are utilized to evenly distribute received weight and elastomeric seals about the neck of the polygonal ball seal functionally sensitive components within a lubricating chamber.

In yet another embodiment, high torque loads and complex rotary motions are transmitted from a motor, through and to an input shaft and to an output shaft, by way of a polygonal-shaped, flexible coupling. The flexible coupling is made to operate wherein one component or device (e.g., shaft) may be misaligned with the input shaft, temporarily and transitorily. The flexible coupling itself consists of a reciprocating polygonal ball and socket design exhibiting a spherical, convex cap component made to provide variations and adjustments in alignment though a pivot point where wear plates are not utilized to distribute received weight and elastomeric seals about the neck of the polygonal ball seal functionally sensitive components within a lubricating chamber.

Flexible couplings of the current embodiments are useful when rotating shafts, that are not necessarily aligned, or are intentionally misaligned, and need to be coupled together in order to transfer rotation and torsion between two devices.

In another preferred embodiment the present invention may be used in downhole drilling, vehicular torque transfer (automotive, marine and space), turbine (wind and hydroelectric) torque transfer and any other torque transfer requiring distribution of large amounts of rotary power realized by peripheral assemblies and devices as torque.

In one preferred embodiment In one preferred embodiment the hexagonal drive shaft that is that is the present invention may be fortified and constructed via the following techniques: conventional heat treatment, flame hardening, laser hardening, cold hardening (cryogenic), roller burnishing, Teflon® or Teflon®-type surface treatment or infusion or any other treatment to harden the surface or reduce friction.

In another embodiment, other polygonal shapes for “mushrooms” may be used as to evenly or unevenly distribute the rotational force through a drill string and to a drill bit where polygons may have equal or unequal width sides, wear plates having two faces, four sides and 4 edges which are flat on each face, and may be of equal or unequal square or rectangular dimensions.

What is claimed is:

1. A flexible coupling joint assembly for transmitting torque comprising:
a male member;
said male member that is a multi-sided ball, or polygonal ball, extending generally in a longitudinal direction;
a female member
said female member that is a socket, with reciprocating multi-sides, or reciprocating said multi-sided or polygonal shape extending generally in a longitudinal direction;
said male member having a portion that is disposed in the female socket;
said male and female members being spaced apart to define a space extending generally in the longitudinal direction;
said female member and said male member separated by a gap that will allow for the optional insertion of an intermediary wear plate member;
said torque transmission having a capacity of 1 to 60,000 ft-lbs;
said flexible coupling joint assembly capable of between 0 to 6 degrees of bend angle.

2. The flexible coupling joint member of claim 1 wherein:
said multi-sided ball or polygonal ball is used to evenly or unevenly distribute rotational force via faces of equal or unequal areas and dimensions; and
said wear plates may be of equal or unequal areas and dimensions.

3. The flexible coupling joint assembly of claim 1 wherein, said male and female members abut one another and no wear/abrasion member is present.

4. The flexible coupling of claim 2 wherein said male member exhibits a fixed pivot point comprising:
a spherical shaped member that is a convex cap component;
said cap component exhibiting a geometrical center that is co-extensive with said multi-sided, or polygonal, ball;
said spherical member that may be integral to, or separate from, said multisided, or polygonal, ball;
said spherical member reciprocating to a mating, similarly radiused bowl in the female socket;
said similarly radiused bowl member may be integral to, or separate from, said female socket;
said spherically shaped bowl having the same geometrical center with said spherical member;
said spherical member and said radiused bowl each having a smooth surface to reduce friction between said members; and
said spherical member being disposed in the spherical bowl and allowed to slide on said spherical interface of said bowl allowing the flexible coupling to pivot about the spherical center of the multi-sided, or polygonal, ball.

5. The flexible coupling joint assembly of claim 4 wherein said end couplings have the ability pivot in a limited spherical arc allowing for torque transfer where male and female members are out of alignment.

6. The flexible coupling joint assembly of claim 5 where said flexible coupling is exhibited on one end or both ends of a connecting shaft.

7. The flexible coupling joint assembly of claim 6 wherein said coupling displayed at one or both ends is confined within a lubrication cavity wherein said lubrication is isolated and protected from outside contaminates and leakage by an elastomeric seal between said male member and female member.

8. The flexible coupling joint assembly of claim 7 wherein each end coupling exhibits a lubrication port for lubricant to pumped into said lubrication cavity.

9. The flexible coupling joint assembly of claim 8 wherein said joint assembly is isolated by said elastomeric seal that is secured and compressed by a retaining ring to form a tighter seal between male and female members.

10. The flexible coupling joint assembly of claim 9 wherein said joint assembly may be further secured by an additional load ring to prevent dislodgement of the male and female members.

11. The flexible coupling joint assembly of claim of claim 5 wherein torque transfer is rated up to a capacity of at least 60,000 ft-lbs., preferably between 20,000 ft-lbs. to 60,000 ft-lbs.

12. The flexible coupling joint assembly of claim 11 wherein said bend angle is between 0 degrees and 6 degrees.

13. A method for transmitting torque and rotary motion between components in a power transmission system by:
providing a flexible coupling joint assembly at one or both ends of a drive shaft said flexible coupling joint assembly comprising:
a male member;
said male member that is a multi-sided ball, or polygonal ball, extending generally in a longitudinal direction;
a female member
said female member that is a socket, with reciprocating multi-sides, or reciprocating said multi-sided or polygonal shape extending generally in a longitudinal direction;
said male member having a portion that is disposed in the female socket;
said male and female members being spaced apart to define a space extending generally in the longitudinal direction;
said female member and said male member separated by a gap that will allow for the insertion of an intermediary wear plate member;
and a pivot point,
said pivot point comprising:
a spherical shaped member that is a convex cap component;
said cap component exhibiting a geometrical center that is co-extensive with said multi-sided, or polygonal, ball;
said spherical member that may be integral to, or separate from,
said multisided, or polygonal, ball;
said spherical member reciprocating to a mating, similarly radiused bowl in the female socket;
said similarly radiused bowl member may be integral to, or separate from, said female socket;
said spherically shaped bowl having the same geometrical center with said spherical member;
said spherical member and said radiused bowl each having a smooth surface to reduce friction between said members; and
said spherical member being disposed in the spherical bowl and allowed to slide on said spherical interface of said bowl allowing the flexible coupling to pivot about the spherical center of the multi-sided, or polygonal, ball.
mating said male member and said female member longitudinally;
packing said joint assembly between male and female members with lubricant to create a lubricant cavity;
sealing said lubricant cavity from contaminants via an elastomeric plug;
locking said elastomeric ring in place with a retaining ring;
fitting said retaining ring over a load ring to prevent dislodgement; and
operating said flexible coupling joint assembly as to distribute torque and rotary power.

14. The method of claim 13 wherein said operating said flexible coupling joint assembly may be accomplished at up to 6 degrees of angle bend and at up to 60,000 ft-lbs.

15. The method of claim 14 wherein said flexible coupling joint assembly has a torque transfer capacity rated up to a capacity ranging from zero to 60,000 ft-lbs., preferably between 20,000 ft-lbs. to 60,000 ft-lbs.

16. The method of claim 14 wherein said flexible coupling joint assembly may be accomplished at zero to 6 degrees of bend, preferably capable of 3 degrees to 6 degrees of angle bend.

17. The method of claim 13 wherein said assembly may be disassembled to provide for repair and replacement of wear plates.
